(19) United States
(12) Patent Application Publication
(10) Pub. No.: US 2002/0129062 A1
(43) Pub. Date: Sep. 12, 2002

(54) Apparatus and method for cataloging data

(75) Inventor: F. Thomas Luparello, Ketchum, ID (US)

Correspondence Address: MORGAN LEWIS & BOCKIUS LLP, 1111 PENNSYLVANIA AVENUE NW, WASHINGTON, DC, 20004, US

(73) Assignee: Wood River Technologies, Inc.

(21) Appl. No.: 09/802,069

(22) Filed: Mar. 8, 2001

(51) Int. Cl. G06F 17/00

(52) U.S. Cl. 707/513

(57) ABSTRACT

A method of cataloging data is provided. The method includes identifying a data source having data representative of a web page, reading, from the data source, source code representative of the text displayed to a viewer of the web page, identifying, based on the source code, whether at least a portion of the data source corresponds to a predetermined search category, and cataloging the data source in accordance with the identifying. An automatic cataloging device is also provided. The automatic cataloging device includes a data storage device and a processor. The processor of the automatic cataloging device obtains an address of a web page having data from the data storage device, reads source code from the web page, identifies data from the source code that corresponds to a predetermined search category, and saves data related to the corresponding data in a predefined category within the data storage device.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The disclosed invention relates generally to identifying and cataloging data from a data source that matches a predetermined search category and, if a match is identified, searching the data source for references to other data sources. The invention also relates to providing cataloged data to parties wishing to have access to the cataloged data.

2. Description of the Background

Given the proliferation of information on many topics and the desire of people to focus on and access information on one or more specific topics within a large amount of data, it has been recognized that there is a need to index information by topics. One method of indexing data is to create a group of predefined categories and save data related to a category in a physical location associated with that category. That may be accomplished by, for example, placing index tabs identified individually by category in one or more binders. Data sheets related to each category may then be placed behind the appropriate index tab for future reference. Moreover, the tabs may be indexed to simplify searching by reference to the index. A user may then select one or more categories from the index in which desired information is most likely to be found and search beneath the appropriate tabs for the desired information.

In another system, such cataloging is achieved by saving a location indicator, such as a pointer, a memory address, a Dewey Decimal address, or a file number that will lead a searching party to the desired information. In the past, such cataloging may have been accomplished by grouping index cards having related data or location indicators in a box, as in a library card filing system. Today, cataloging is often accomplished by storing related data or location indicators in a computer searchable database.

The Internet has become a particularly large source of data. The existing amount of information available over the Internet and World Wide Web is staggering. There are literally millions of “web pages” full of information on almost any topic of interest. Moreover, the amount of information available on the Internet is increasing rapidly. The sheer volume of information accessible through the Internet has made the search for specific types or categories of information on the Internet a significant challenge. The complexity of that challenge may be better understood with some general background information regarding the Internet and World Wide Web.

The Internet comprises a network of computers, dumb terminals, or other, typically processor-based, devices interconnected by one or more forms of communication media. Typical interconnected devices range from handheld computers and notebook PCs to high-end mainframe and supercomputers. The communication media include twisted pair, co-axial cable, optical fibers and radio-frequencies. Each interconnected device is equipped with software and hardware that enables it to communicate using the same procedures or languages. Those procedures and languages are generally referred to as protocols, which are often layered over one another to form something called a “protocol stack.” One such protocol is referred to as the Hypertext Transfer Protocol (HTTP) and it permits the transfer of Hypertext Markup Language (HTML) documents between computers. The HTML documents are often referred to as “web pages” and are files containing information in the form of text, videos, images, links to other web pages, and so forth. Each web page is stored in an interconnected device that is typically referred to as an “Internet Server,” and has a unique address referred to as a Universal Resource Locator (URL). The URL is used by a program referred to as a “web browser” located on one interconnected computer to find a web page stored somewhere on another computer connected to the network. That creates a “web” of computers each storing a number of web pages that can be accessed and transferred using a standard protocol, and hence this web of computers is referred to as the World Wide Web.

As the volume of data on the Internet has grown dramatically, the task of searching through that data to find data related to a specific subject has become increasingly daunting. A complete field of technology has arisen that focuses upon making it easier for a user to find information available over the Internet. There are a large number of “search engines” that permit the user to enter key words or phrases. The search engine searches the Internet, or a portion thereof, to find web pages that contain the key terms and presents the results to the user. Given the sheer volume of information available over the Internet and World Wide Web, however, search time for such a task can be extremely long. That time element is particularly problematic in an age when users are demanding faster performance in information retrieval tools. Moreover, because such key-word searches turn up any instance of the key word in the searched database, the search results often have little relevance to the user's initial request.

To accelerate the search process, some search engines build internal databases using a term-searching, Internet-indexing facility referred to as a “web crawler.” The idea behind a web crawler is that by building an internal database, much of the search work can be done prior to a user's request for information, thereby decreasing search times by redirecting the user's inquiry to the smaller, results database generated in advance by the web crawler. A web crawler performs as its name suggests. The program periodically “crawls” or searches the Internet and attempts to score web pages by the relativity of information available in each web page to a search term. The score for each web page is stored in a database that is accessible to the search engine. In that manner, when a user enters a search term, the internal database is searched for matching terms in a relatively fast and efficient manner.

A primitive web crawler searches for certain terms in a web page key term facility, such as a meta-tag, and indexes the web page according to the terms found therein. That indexing facility stores the address for each web page having the desired term in a database. Then when a search is requested, the indexing facility provides addresses of pages having the search term. A problem with such primitive web crawlers, however, is that they are designed to collect a limited set of information about the web page. Each web page typically has a meta-tag, which is a list of terms provided by the designer that attempts to identify the content found within the web page. The web crawler retrieves those terms and stores them in a database. That list of terms, however, is typically limited to terms the web designer chooses or deems significant. Consequently, it may not be accurate or comprehensive. Moreover, in many instances, the list may contain terms that are misleading. For example, a web page having information about a particular brand of car may include in its list of terms the names of several competitors. Thus, when the user inputs the competitor's name in a search engine, the unintended web page may be retrieved as part of the search results. Furthermore, primitive web crawlers have been found to index many pages of unrelated data because many terms have multiple connotations and are used in connection with a variety of subjects. Thus, when a search of the database is performed, the result is often a long list containing many unrelated pages. It would, therefore, be beneficial to better refine the results of such an Internet search.

An advanced web crawler counts the number of times a certain term appears in a web page meta-tag and saves the web page address containing the term, along with the number of appearances of the desired term therein. When a search is performed for the term thereafter, the resulting list of addresses is displayed by rank so that the addresses in which the term occurs most frequently appear first in the listing. The advanced web crawler facility provides better results than the primitive web crawler, but provides no assurance that a web page is related to a certain subject matter, because it too simply matches terms found in a meta-tag that may be employed in connection with a variety of subjects.

Another Internet indexing facility utilizes people to review the actual content of web pages to assure that, at the time of the review, the page is related to a search term by which the page will be indexed. That method of indexing web pages, however, is labor intensive and costly and, given the exponential increase of web pages, that indexing scheme has already become impractical

An additional problem encountered with each of those web crawling facilities is an inability to know when data contained in a web page changes so that the index may be updated. Another problem encountered by those facilities is an inability to find new web pages in the ever growing Internet so that results provided to a user will be complete. Because the Internet is open for use by everyone and the growth of users, web sites, and web pages is great, it is difficult for an indexing facility to find each new web page that is posted on the Internet. Furthermore, it is time consuming and expensive to attempt to index every web page existing on the Internet and World Wide Web, particularly where humans are employed to review each web page and the results provided by indexes have many shortcomings.

Another problem with conventional web crawlers is that they are designed to locate general information. A conventional web crawler searches for web pages to be indexed in a random manner and indexes the web pages and sites that it encounters within an initial set of search parameters or categories. Those conventional web crawlers are, therefore, not optimized to locate a specific set or domain of information. Accordingly, the conventional web crawler is not efficient or effective when attempting to completely catalog or index specialized information.

Thus, there is a need for a method and an apparatus for accurately cataloging data available on the Internet. There is also a need for a method and an apparatus for identifying web pages that are relevant to a category of desired data and for finding all data that is relevant to an index category on the Internet. There is furthermore a need for a method, an apparatus, and a system for checking web pages that are currently indexed to update the index for changes made in the web page.

### SUMMARY OF THE INVENTION

The present invention is directed to a method and an apparatus for identifying and cataloging data from a data source that corresponds to a predetermined search category. The invention provides an automatic method of searching a large number of databases, such as Internet web pages, for desired information, categorizing the desired information when it is found in those databases, and saving desired information and/or the address at which that information may be found in categories for future reference. The present invention also provides a method of finding additional databases in which to search by extracting links from databases in which desired information is discovered.

In accordance with one form of the present invention, there is provided a method of cataloging data. The method includes identifying a data source having data representative of a web page, reading, from the data source, source code representative of the text displayed to a viewer of the web page, identifying, based on the source code, whether at least a portion of the data source corresponds to a predetermined search category, and cataloging the data source in accordance with the identifying. The term “source code” as utilized herein includes source code that is utilized to create a web page, data that is contained in a database, and any mechanism for accessing data contained in a web page or database. The data that may be accessed includes meta-tags, text that is displayed to viewers of the web page, captions, commentary text, java script, any data contained within the page source code, or other forms of displayed or non-displayed text and may furthermore include results of execution of the source code or a compilation or interpretation thereof.

In accordance with another embodiment of the present invention, an automatic cataloging device is also provided. The automatic cataloging device includes a data storage device and a processor. The processor of the automatic cataloging device obtains an address of a web page having data from said data storage device, reads source code, including text displayed on the web page, from the web page, identifies data from the read source code that corresponds to a predetermined search category, and saves data related to the identified data in a predefined category within said data storage device.

Thus, the present invention provides a method and apparatus whereby data available on the Internet may be accurately indexed. The present invention also provides a method and apparatus for identifying web pages that are relevant to a category of desired data and for finding all data that is relevant to an index category on the Internet. Furthermore, the present invention provides a method and an apparatus for checking web pages that are currently indexed to update the index for changes made in the web page.

Accordingly, the present invention provides solutions to the shortcomings of prior cataloging processes. Those of ordinary skill in the art will readily appreciate, therefore, that those and other details, features, and advantages will become further apparent in the following detailed description of the preferred embodiments.

### BRIEF DESCRIPTION OF THE DRAWINGS

The accompanying drawings, wherein like reference numerals are employed to designate like parts or steps, are included to provide a further understanding of the invention, are incorporated in and constitute a part of this specification, and illustrate embodiments of the invention that together with the description serve to explain the principles of the invention. In the drawings:

FIG. 1 is a schematic illustration of a system in which the present invention may be employed;

FIG. 2 is a flow diagram illustrating an embodiment of an Internet cataloging process of the present invention; and

FIG. 3 is a flow diagram illustrating an embodiment of an intelligent agent of the present invention.

### DETAILED DESCRIPTION OF THE INVENTION

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements found in typical cataloging systems and computer networks.

The concepts and features of the present invention are now illustrated in the context of a particular application. The following example is directed to a method of identifying sales opportunities on the Internet and categorizing those sales opportunities by Standard Industrial Classification. Standard Industrial Classification, which will also be referred to herein as “SIC,” applies a four-digit number to each known industry in the U.S. economy, thereby classifying those industries in terms of goods and services associated with those industries. The present invention also includes systems and apparatuses for performing the method. Categorizing by SIC will furthermore be recognized as one example of a use of the present invention. It will, however, be recognized that any type of cataloging using any type of category is contemplated by the present invention. Any known systematized catalog may utilize the present invention to classify, categorize, or otherwise systematically arrange data. An arbitrary or original cataloging system may also utilize the present invention to systematically arrange data. It will be recognized, in addition, that the North American Industry Classification System may be utilized in place of the Standard Industrial Classification. In addition, while a search of the Internet is contemplated in the following example, it will be recognized that a search of any database, such as a wide area network, a local area network, or a single storage facility may be performed utilizing the present invention. Thus, the SIC classification described herein provides an example of the use of the present invention, but is not intended to limit the scope of the invention to that application.

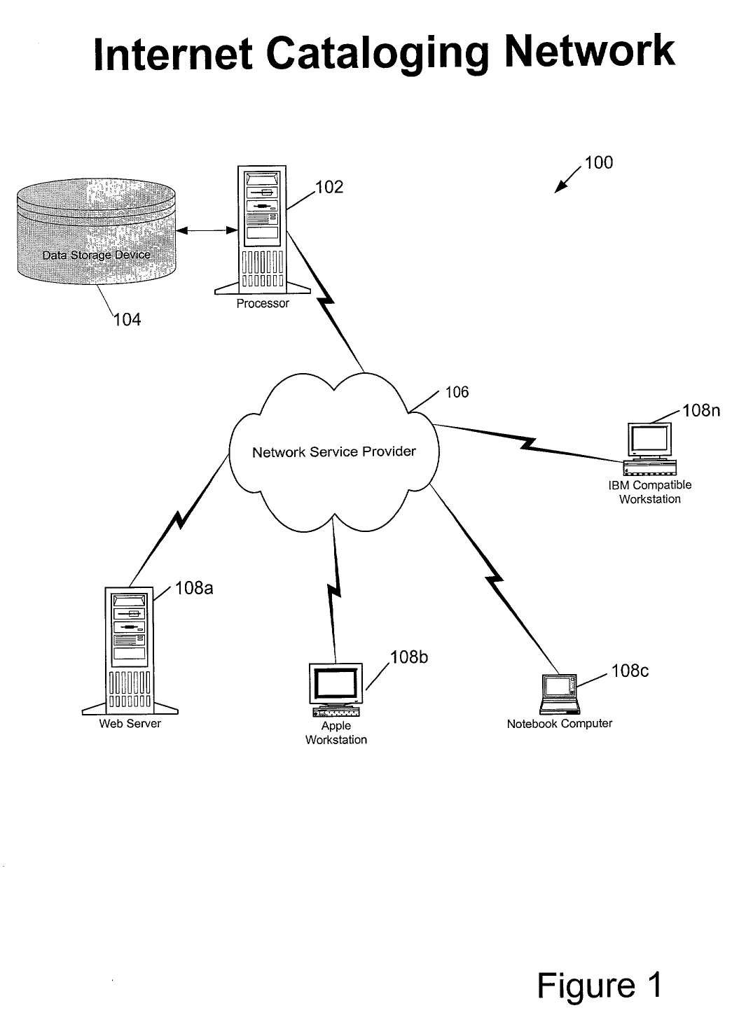

FIG. 1 illustrates a system 100 for identifying sales opportunities on the Internet and categorizing those sales opportunities by SIC. The system 100 includes a processor 102 coupled to one or more data storage devices 104. The processor 102 may comprise, for example, a mainframe computer, a mini-computer, a microcomputer, or a personal computer. The data storage device 104 may, for example, be a magnetic storage device, a random access memory device (RAM), a read only memory device (ROM), or any other computer readable medium. The processor 102 may furthermore use an operating system such as, for example, a Microsoft® Windows NT® operating system, a Linux® operating system, a Unix® operating system or an Apple® operating system. Furthermore, the processor 102 and data storage devices 104 may organize data into a database utilizing, for example, an Oracle® database program.

The processor 102 is also coupled to the Internet through, for example, a network service provider 106. The processor 102 may, thus, access network devices 108 available on the Internet. The network devices may include, for example, web servers 108a, Apple® compatible computers 108b, notebook computers 108c, and other processor based devices designed to communicate on the Internet, including Unix based computers and IBM® compatible computers 108n. The processor 102 may retrieve and catalog information stored in the network devices 108. When retrieving data, the processor may, for example, copy all text data available on a web page to access that data repeated without creating an excessive amount of traffic at the web page. While it is possible to search a web page directly without copying that web page, the present invention is capable of performing many searches on a single web page, and such activity may place an undesirable demand on a web page, thereby causing a reduction in performance at the web page. Thus, copying the web page contents into a memory device that is accessible to the processor performing the Internet cataloging functions and searching the copy is generally beneficial.

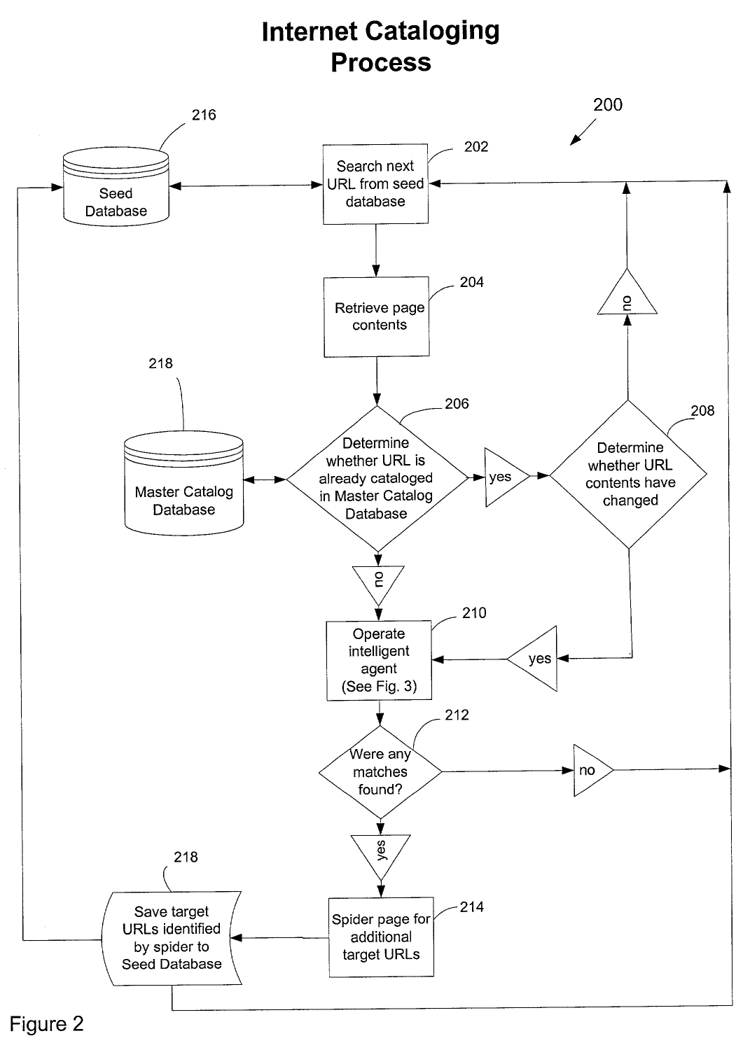

FIG. 2 illustrates a process 200 of cataloging data residing on the Internet. Of course, the present invention may be used to catalogue data contained in any web site, web page, database, or data storage facility. The cataloging process 200 begins by identifying at least one data source having data that may include at least one piece of data that is desired to be referenced in a category. The data source identification process may begin utilizing a database of seed references as depicted in FIG. 2 at 216, or may begin with an empty database to be populated by the process. The seed database 216 may furthermore be saved in one or more data storage devices, or may be stored in a single data storage device such as, for example, the data storage device 104 depicted in FIG. 1. Other databases described herein may also be stored in separate data storage devices or may be stored in combination with the seed database 216 on a single data storage device 104. The primary factor in determining the quantity and architecture of the data storage devices is the amount of data that is to be saved.

The seed database 216 may be utilized to store pointers such as locations or addresses of web pages or other data sources to be searched for applicable data. Each additional data source that is discovered may be added to the seed database 216 and each data source that has been searched may be deleted from the database so that the seed database 216 contains an updated list of references to be searched. Alternately, addresses of data sources that have been previously searched may be retained in the seed database so that those data sources may be searched again in the future. By re-searching previously searched data sources, the cataloged data saved by the present invention may be updated when new or changed data becomes available in the searched data sources.

To facilitate updating of indexing related to a web page, a listing of searched web pages may be retained in a database that is separate from the seed database 216. That retained listing may, for example, include the address of each web page searched or the address of each address that was searched and resulted in at least one match, i.e., at least one piece of data identified as corresponding to a search term. That retained listing may, furthermore, be saved in the data storage device 104 to be accessed periodically or when no unsearched page addresses are available in the seed database 216. Moreover, where it is likely that web pages having no matches will have matches in the future, it may also be desirable to retain those page addresses to facilitate periodic re-searching of those pages. In contrast, where it is unlikely that a web page having no resultant matches will include matches in the future, it may be efficient to retain only addresses of web pages that have been found to include matches.

The process steps described herein may, furthermore, be performed by the processor 102. At 202, an address of a data source is read from the seed database 216. That data source may be a source that has been previously searched or a source that is to be searched for the first time. At 204, contents of the data source, which in this example will be a web page, are retrieved. Those contents may be retrieved in the form of a source code, or portion thereof, that is used to create the web page. All text that is displayed to a web surfer accessing the web page may be retrieved, including captions, and commentary text. In addition, non-displayed text, such as meta-tags and java script, may be retrieved. Unlike other cataloging facilities, however, the present invention is concerned primarily with searching the actual text displayed on a web page rather than data in a meta-tag or other condensed keyword data source used in connection with the web page. In that way, the present invention is able to find actual desired data and catalog that data and/or the address at which that data may be found, rather than catalog web addresses hoped to contain desired data because a meta-tag contains a particular word or phrase.

A location identifier, such as a uniform resource locator or URL, for the web page being searched is compared to URLs of web pages stored in a master catalog database 218 to determine whether the web page has already been cataloged in the database at 206. If the web page has previously been cataloged, the contents of the web page are checked at 208 to determine whether any changes have been implemented in the data stored at that web page since the web page was last accessed. That determination may be accomplished by many methods including, for example, comparing the number of characters contained in each version of the web page or computing a check-sum for each version and assuming that if the number of characters or the check-sum match, that the data within the page is unchanged. If the prior and current contents of the web page match, the method may end operation, or may return to 202 and repeat the test with another URL from the seed database 216.

The URL of a web page may furthermore be normalized to create an absolute address for the web page in a situation in which the web page is accessed by a relative address. Such normalization typically involves taking the relative address and appending the URL of the related page to create a normalized or absolute URL. That absolute URL may then be stored with the match related data for future reference.

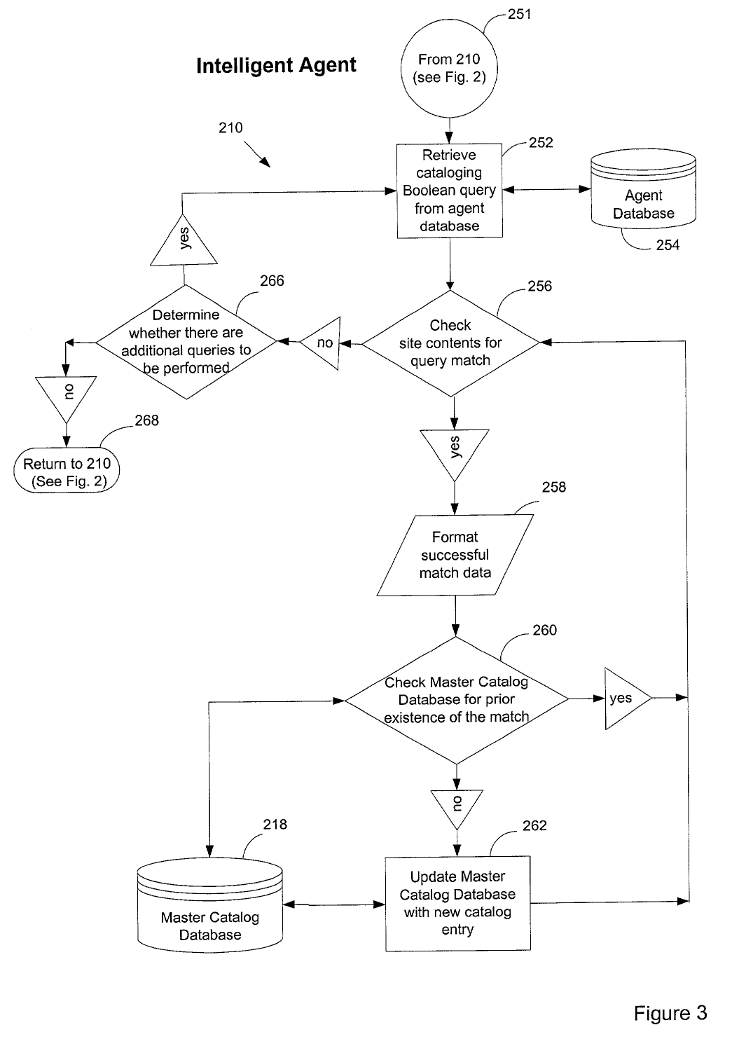

If the web page has not already been cataloged, or if the contents of the web page have been modified since that page was last cataloged, the present invention will execute the intelligent agent at 210. The intelligent agent 210 reviews data from the web page and categorizes data or portions of data that are relevant to a desired category or the address of the web page at which such data is found. Thus, in the present example, any sales opportunities, which may appear in the data as notices that a good or service is desired to be purchased, are categorized in one or more SICs. The intelligent agent 210 may, for example, include a software program executed by the processor 102 and may save relevant data in a master catalog database 262 that is stored in the data storage device 104. The intelligent agent is described in more detail in connection with FIG. 3, hereinbelow.

The present invention is furthermore self-propagating. At 212, a determination is made as to whether the intelligent agent discovered any category matches in the data source. In this example, if at least one match is found in the data source, a decision is made that it is worth considering the contents of any other web page referenced in the data source. At 214, the present invention spiders the web page to identify and save web page references, or URLs, contained therein. Web page references may be identified, for example, by searching the contents of the data source for a character string such as “http:” and extracting that string and the string immediately following that string until a space is encountered. The term “http:” is common to most Internet addresses and is typically followed by a continuous string of characters that identifies a specific web page or site. Thus, the term “http:” and the connected string will comprise a specific Internet address. The target URLs that are identified in the spidering process are saved to the seed database 216 at 218, to be searched in future iterations of the process. The cataloging process is then reinitiated at 220 and the process is performed once again on another URL stored within the seed database 216. Alternately, all searched web pages, including those not having matches, may be scanned for references to other web pages if it is likely those referenced web pages may lead to additional category matches. Thus, by identifying those strings and saving them to the seed database 216 for future searching, the present invention is able to regularly find new web pages that are likely to have desired data. When all URLs in the seed database 216 have been searched, the process may stop until one or more URLs are added to the seed database 216.

FIG. 3 illustrates a process flow in a certain embodiment of the intelligent agent 210. At 251, the cataloging process 200 enters the intelligent agent 210 portion of its methodology. It will be recognized that the web page contents may have been retrieved at an earlier time such as, for example, at step 208, when a comparison of the prior contents of the web page to the current contents was performed. If, however, a separate processor is utilized or if for any reason the contents of the page are not available, those contents should be retrieved so that the intelligent agent may act upon those contents. It should also be recognized that, unlike other indexing facilities that search only a portion of data in a web page, such as the meta-tag, the data searched by the intelligent agent 210 may include all accessible text data in the web page.

At 252, a query is retrieved from an agent database 254. The agent database 254 may reside on the data storage device 104 or a separate storage device. The query may, furthermore, be one of a plurality of Boolean queries. When categorizing sales opportunities by SIC, for example, a list of thousands of Boolean queries may be contained in the agent database 254. The contents of every web page accessed may, furthermore, be searched for a match to every Boolean query. Thus, a tremendous amount of data searching may be performed by the present invention quickly and without human intervention.

Each Boolean query may, for example, compare data found within each web page to a word, word portion, phrase, or a combination thereof found proximate to each other, that likely identifies the data or a portion thereof as fitting within one of the desired categories at 254. In this example, those categories are SICs. As an example, SIC category 3585 includes Air Conditioning and Warm Air Heating Equipment. Equipment incorporated under that category include such diverse equipment as refrigeration machinery, cold drink dispensing equipment, and furnaces. One or more separate terms or phrases may, therefore, be searched for each of those types of equipment in each web page. Such search terms may include, for example, the term “furnace” alone, “refrigeration” within a certain number of words of “machine,” or “cold” within a certain number of words of “drink” and also within a certain number of words of “dispensing.” It will be recognized that variations of certain words or terms may be searched such as “furnace” and “furnaces.”

The Boolean queries may furthermore search the contents of the data source, for example, for a string of characters matching the word “demolition” to identify goods and services related to demolition and wrecking. A separate Boolean query may search the contents for the character string “wrecking” and place the results in the same category as the results of the search for the string “demolition.” In that way, all goods and services related to demolition and wrecking may be identified and placed in the same category regardless of whether the term “demolition” or “wrecking” is used in connection with the goods and services. In another example, the word “bituminous” may be identified and placed in a particular category only when found near the word “surface” to, for example, categorize bituminous materials found near the surface separately from bituminous materials found more deeply underground.

At 256, the present invention will determine whether a match was found for the Boolean query. For example, if a term is searched and a match to that term is found in the data source, then a match would have been found for that Boolean query. If, alternately, the Boolean query term is not found anywhere in the text of the data source, then no match would have been found. Each time a Boolean query is completed, if no matches are discovered at 256, the present invention proceeds to 266 where additional queries may be performed.

When a match is revealed, data related to the match may be formatted and placed in a standard record format at 258. Data related to the match may include, for example, the address at which the match was found, or data related to the match, or both. The formatting may include, for example, placing the web page address having a match in a data storage device and identified in connection with a category with which the query is associated. Additionally, the data matched to the Boolean query, or the data matched in combination with surrounding data, may be saved, together with the address at which that data was found, in a standard record associated with the matching category. In that way, not only is the address for each web page having a match saved and available for quick reference, the text of the match is also available for quick reference.

The data to be formatted each time a match is made to a category may include a variety of information including, where applicable, the goods or services desired by the purchaser, the quantity of goods or services desired by the purchaser, qualities that the goods or services are required to include, pricing information regarding the goods or services, a date when the goods or services will be required, a date of an auction for the goods or services, and the identity of the purchaser. The identity of a party wishing to make a purchase may, for example, be the administrator of the web site or one of a number of purchasing parties listed on the web site. Ultimately, any information that may be useful to a seller and may be revealed in the web page may be saved for future reference by such sellers.

In addition, a weight associated with the match may be placed in the record and saved. Such a weight is intended to be indicative of the degree of relativity between the match and the category. That weight may be a number, wherein a larger number indicates that the match is more closely related to the category than a match having a smaller number. The weight may furthermore be calculated by, for example, giving greater weight or applying a larger weight number to a match found in a particular portion of source code, such as the portion of the source code that is displayed to a viewer. Alternately, the weight may be increased by each occurrence of a search term or when search terms are found in close proximity.

At 260, the present invention compares the current record to previously discovered record matches to avoid saving a single record more than one time. For example, where records are placed in a standard format, if the match has been made previously, the previous record and current record should be identical. Therefore, the current record may be compared to each previous record in the master catalog database 264 or within the category to which the current record was matched and, if the identical record is found, the current record may be discarded. If, however, the current record is not already saved in the master catalog database 264, the present invention proceeds to 262.

At 262, the present invention saves the record having the new match. That record may be saved in the master catalog database 264 which, as has previously been discussed, may be stored in the data storage device 104 common to all databases, or stored in one or more separate storage devices. The saved records are then available for consideration by category. For example, in the present example all sales opportunities discovered in the Internet are categorized and saved by SIC, or by SIC and subcategory to which the sales opportunities are matched. Those records may furthermore be accessible by, for example, manufacturers, service providers, or third parties that represent manufacturers and service providers. For example, a manufacturer's representative may pay a periodic fee in return for which it is provided a password that permits the manufacturer's representative to access the records or portions of the records. The manufacturer's representative may then periodically access the records by logging into a web site maintained by the record provider, entering the password, and requesting all records in a desired category or subcategory. Accordingly, the manufacturer's representative may acquire regular updates as to markets for the manufacturer's goods.

Of course, a single data source may contain more than one reference that matches a query, and it would be beneficial to find every match to the query if data from the data source is to be saved in the record. Thus, when a match is found, regardless of whether the match was previously recorded or is newly recorded, the present invention may return to 256 to search the remaining contents of the data source for additional matches to the current query. For example, the present invention may return to the location in the data source where the last match was discovered and continue searching the contents from that point until another match is discovered or the end of data source contents is reached. Thus, the determination that no more searching for matches to the current query are appropriate may, for example, be based on a determination that the entire contents of the web page have been searched for matches, all matches have been discovered, and the end of the data content has been reached. As will be recognized, the present invention may return to search the contents any number of times.

Alternately, if only the address of the web page in which a match is made is to be saved, a single match may suffice to confirm that matching data may be found at the subject address, and it may be desirable to move to another query once a single match has been established. Thus, the determination that no additional searching will be performed for a particular query in that embodiment would be a recognition that a first match has been identified. Once all pertinent matches to a particular query have been identified, the decision at 256 will be that no more checks for matches to the current query are appropriate and the present invention will proceed to 266. At 266, a determination is made as to whether additional queries should be performed for the current web page. In many applications, all queries will be performed on every web page to draw all sales opportunities from that web page. In certain applications, however, wherein, for example, it is expected that a limited number of categories may be matched to the web site, only a subset of the queries may be utilized. Thus, where, for example, a web page is directed to air conditioning and warm air heating equipment, only the queries related to such equipment may be utilized when searching that web page. If additional queries are determined to be appropriate at 266, the intelligent agent may return to 252 to search the contents of the web page for additional matches in the same category and/or additional matches in other categories. If no additional queries are to be performed on the contents of the current data source, the intelligent agent may stop operation on the current data source at 268 and return to the cataloging process depicted in FIG. 2 for further processing.

It should be noted that records saved by the present invention may be reviewed periodically and removed when appropriate. For example, all records that have been held for at least a predetermined time may be assumed to no longer be relevant and may be deleted from the data storage device. Alternately, when a data source is researched and the data is determined to have changed, any old data may be deleted from the data storage device. In another embodiment, data is deleted from the data storage device only when that data has been removed from the data source. When a date, such as an auction or purchasing requirement date, is associated with the record, the record may be deleted when that date has passed. It will be recognized that many conditions may be utilized to determine when records should be deleted so that portions of the data storage devices are not wasted by storage of outdated information.

While the invention has been described in detail and with reference to specific embodiments thereof, it will be apparent to one skilled in the art that various changes and modifications can be made therein without departing from the spirit and scope thereof. In particular, it should be noted that the present invention may be utilized to catalog data found other than on the Internet and may furthermore be utilized to find additional databases found other than on the Internet. Thus, it is intended that the present invention cover the modifications and variations of this invention provided that they come within the scope of the appended claims and their equivalents.

What is claimed is:

1. A method of cataloging data on a network, comprising:
identifying a data source having data representative of a web page;
reading, from the data source, source code representative of the text displayed to a viewer of the web page;
identifying, based on the source code, whether at least a portion of the data source corresponds to a predetermined search category; and
cataloging the data source in accordance with said identifying.

2. The method of claim 1, wherein cataloging the data source includes cataloging a pointer indicating a location of the data source.

3. The method of claim 2, wherein the pointer is an address.

4. The method of claim 1, wherein cataloging the data source includes cataloging data copied from the source code.

5. The method of claim 4, wherein the data copied from the source code includes all data displayed as text on the web page.

6. The method of claim 4, wherein the data copied from the source code includes the portion of the displayed text that corresponds to a predetermined search category.

7. The method of claim 1, wherein identifying a data source includes retrieving a data source pointer that identifies a location of a data source from a database stored in a data storage device.

8. The method of claim 7, wherein the data source pointer includes an Internet address.

9. The method of claim 7, wherein the data source pointer includes an address of a data source stored in a database in a data storage device.

10. The method of claim 1, wherein the displayed text includes all text displayed by the data source.

11. The method of claim 1, wherein retrieving source code includes copying the displayed text from the data source into a memory device.

12. The method of claim 1, further comprising examining the source code.

13. The method of claim 1, wherein identifying, based on the source code, whether at least a portion of the data source corresponds to a predetermined search category includes cataloging data related to the data source, and further comprising comparing the identified data to data previously cataloged from that data source.

14. The method of claim 13, further comprising cataloging the identified data only if the identified data does not correspond to any previously identified data.

15. The method of claim 1, wherein identifying, based on the source code, whether at least a portion of the data source corresponds to a predetermined search category includes searching the displayed text for a predefined string of characters.

16. The method of claim 1, wherein identifying, based on the source code, whether at least a portion of the data source corresponds to a predetermined search category includes searching the source code for data corresponding to a Boolean query.

17. The method of claim 1, wherein identifying, based on the source code, whether at least a portion of the data source corresponds to a predetermined search category includes searching the displayed text for data corresponding to at least one of a plurality of Boolean queries.

18. The method of claim 1, wherein the search category includes a standard industry code category.

19. The method of claim 1, wherein said cataloging includes:
determining that the data source has previously been retrieved;
comparing data from the data source with data previously contained in the data source; and
establishing that data in the data source has been modified.

20. The method of claim 19, wherein comparing data from the data source with data previously contained in the data source includes:
calculating a number indicative of the number of characters contained in source code previously read from the data source;
calculating a number indicative of the number of characters contained in source code currently read from data source; and
wherein establishing that data in the data source has been modified includes establishing that the number indicative of the number of characters contained in the source code previously contained in the data source is not equal to the number indicative of the number of characters contained in the currently read source code.

21. The method of claim 20, wherein cataloging includes saving a number indicative of the number of characters contained in the source code.

22. The method of claim 20, wherein identifying data from the displayed text that corresponds to a predetermined search category is not performed if the number of characters contained in the source code currently read from data source is the same as the number of characters contained in the source code previously read from the data source.

23. The method of claim 19, wherein comparing data from the data source with data previously contained in the data source includes:
calculating a previous checksum indicative of at least one quality of data contained in source code previously read from data source;
calculating a current checksum indicative of at least one quality of data contained in the source code currently read from data source; and
wherein establishing that data in the data source has been modified includes establishing that the previous checksum is not equal to the current checksum.

24. The method of claim 23, wherein the quality includes a quantity of characters.

25. The method of claim 23, wherein the quality includes an identity of characters.

26. The method of claim 23, wherein the quality includes an arrangement of characters.

27. The method of claim 1, wherein cataloging includes formatting data related to the data source as a record.

28. The method of claim 1, further comprising accessing cataloged data.

29. The method of claim 1, further comprising accessing cataloged data from the Internet.

30. The method of claim 26, wherein access to cataloged data requires entry of a predetermined password.

31. The method of claim 1, further comprising searching the source code for a reference to a second data source.

32. The method of claim 1, further comprising searching the source code for a reference to a second data source only if at least a portion of the data source corresponds to the predetermined search category.

33. The method of claim 1, wherein the data source is identified by a pointer indicating a location of the data source.

34. The method of claim 33, further comprising storing the pointer of a data source.

35. The method of claim 33, further comprising re-searching a previously read data source.

36. The method of claim 33, further comprising storing the pointer of a cataloged data source.

37. The method of claim 36, further comprising re-searching a cataloged data source.

38. A method of cataloging data available through a network, comprising:
accessing a web page;
retrieving source code, including text displayed on the web page, from the web site;
querying the retrieved source code for data corresponding to a predefined category;
saving data related to the corresponding data to a data storage device; and
searching the source code for an address of another web page when corresponding data has been identified in the source code.

39. An automatic web page cataloging device, comprising:
a data storage device; and
a processor containing instructions that, when executed by said processor, cause said processor to:
obtain an address of a web page having data from said data storage device;
read source code, including text displayed on the web page, from the first data source;
identify data from the source code that corresponds to a predetermined search category; and
save data related to the corresponding data in a predefined category within said data storage device.

40. The device of claim 40, wherein said processor performs without human intervention.
